(19) United States
(12) Patent Application Publication
(10) Pub. No.: US 2026/0170525 A1
(43) Pub. Date: Jun. 18, 2026

(54) INFORMATION PROCESSING TERMINAL AND INFORMATION PROCESSING METHOD

(71) Applicant: Toshiba Tec Kabushiki Kaisha, Tokyo (JP)

(72) Inventor: Sadatoshi OISHI, Fuji Shizuoka (JP)

(21) Appl. No.: 19/327,706

(22) Filed: Sep. 12, 2025

(30) Foreign Application Priority Data
Dec. 16, 2024 (JP) 2024-220167

(51) Int. Cl. G06Q 30/0207; G06T 19/00; G06T 19/20; H04W 64/00

(52) U.S. Cl. CPC G06Q 30/0207; G06T 19/006; G06T 19/20; H04W 64/006

(57) ABSTRACT

An information processing terminal includes an interface device connected to a reader apparatus that is configured to read RFID tag information from RFID tags, a camera configured to capture an image, a control device configured to execute a program for operating the information processing apparatus. The control device executes the program to display an augmented reality (AR) interface on top of the image captured by the camera, estimate a location of the information processing terminal, acquire the RFID tag information read by the reader apparatus, and transmit the acquired RFID tag information to a server.

### CROSS-REFERENCE TO RELATED APPLICATION(S

This application is based upon and claims the benefit of priority from Japanese Patent Application No. 2024-220167, filed on December 16, 2024, the entire contents of which are incorporated herein by reference.

### FIELD

Embodiments described herein relate generally to an information processing terminal and an information processing method.

### BACKGROUND

In the related art, there are systems that manage inventory of products using wireless tags attached to the products in stores or the like. In such systems, inventory tasks are performed by scanning the wireless tags with portable radio frequency identification (RFID) readers. Inventory tasks include, for example, tasks for checking which products and how many of the products are placed on shelves. However, in carrying out inventory tasks using wireless tags, it is difficult to visually confirm how far the scanning is actually performed on the shelves. For example, when the inventory tasks are interrupted for some reason, it may be unclear how far scanning has been performed when the tasks are restarted, which leads to re-scanning of already scanned regions or missing regions that are not yet scanned.

### BRIEF DESCRIPTION OF THE DRAWINGS

FIG. 1 is a block diagram illustrating an overview of a configuration example of an information processing system according to an embodiment.

FIG. 2 is an external view illustrating a configuration example of the external view of a wireless tag communication apparatus.

FIG. 3 is a block diagram schematically illustrating a first configuration example of a control system in the wireless tag communication apparatus.

FIG. 4 is a block diagram schematically illustrating a second configuration example of the control system in the wireless tag communication apparatus.

FIG. 5 is a diagram illustrating a data structure of scan information.

FIG. 6 is a schematic diagram illustrating an example of an object display image displayed on the wireless tag communication apparatus.

FIG. 7 is a flowchart illustrating an example of an operation of the wireless tag communication apparatus.

FIG. 8 is a sequence diagram illustrating another example of the operation of the wireless tag communication apparatus.

FIG. 9 is a sequence diagram illustrating still another example of the operation of the wireless tag communication apparatus.

### DETAILED DESCRIPTION

In general, according to one embodiment, an information processing terminal includes an interface device connected to a reader apparatus that is configured to read RFID tag information from RFID tags, a camera configured to capture an image, a control device configured to execute a program for operating the information processing apparatus. The control device executes the program to display an augmented reality (AR) interface on top of the image captured by the camera, estimate a location of the information processing terminal, acquire the RFID tag information read by the reader apparatus, and transmit the acquired RFID tag information to a server.

Hereinafter, an embodiment will be described with reference to the drawings. The drawings used to describe the following embodiment may have scales of various units appropriately altered. Also, for description purposes, in the drawings used to describe the following embodiment, configurations are omitted in some cases.

### Embodiment

### Configuration Example

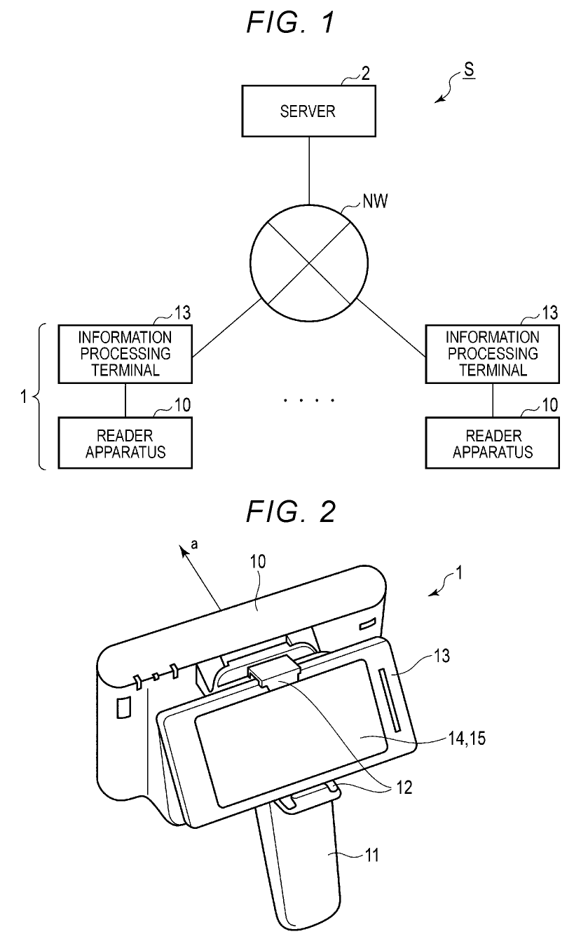

FIG. 1 is a block diagram illustrating an overview of a configuration example of an information processing system S.

The information processing system S is a system that manages inventory of merchandise items in a store. The store is assumed to be an actual store. The merchandise items include tangible items such as clothing, food, and beverages, but the embodiment is not limited thereto. The store may be a store that primarily sells merchandise items such as tangible items or may be a store that primarily provides services. For example, the store that mainly sells merchandise items such as tangible items is a supermarket or a home improvement center, but the embodiment is not limited thereto. For example, the store that mainly provides services is a restaurant or a gym, but the embodiment is not limited thereto.

A transaction of a merchandise item refers to exchange of payment from a customer to a store in connection with the sale of a merchandise item in the store. From the store's perspective, the transaction is selling a merchandise item. From the customer's perspective, the transaction is purchasing a merchandise item.

The information processing system S includes a wireless tag communication apparatus 1 and a server 2. The wireless tag communication apparatus 1 and the server 2 are connected to be able to communicate with each other via a network NW. The network NW includes one or more networks among various networks such as the Internet, a portable communication network, and a local area network (LAN). The LAN may be a wireless LAN or a wired LAN. The information processing system S refers to a system that includes at least one electronic apparatus.

The wireless tag communication apparatus 1 includes a reader apparatus (also referred to as a base apparatus) 10 and an information processing terminal 13 serving as a user interface. The information processing system S may include a plurality of wireless tag communication apparatuses 1.

The wireless tag communication apparatus 1 is an apparatus that communicates with an RFID tag (more generally referred to as a wireless tag). The wireless tag communication apparatus 1 is a wireless tag reading apparatus that reads tag information or the like recorded on an RFID tag by communicating with the RFID tag. The RFID tag is attached to, for example, a product such as a merchandise item or a component. The RFID tag records tag information including information for identifying a product to which the tag is attached in an internal memory. The tag information includes identification information of the tag. The configuration of the wireless tag communication apparatus 1 will be described below.

The server 2 is an electronic apparatus that manages inventory information. For example, the server 2 manages the inventory information of merchandise items at a store X. The inventory information includes scan information acquired from scanning by the wireless tag communication apparatus 1. The scanning involves irradiating of radio waves and reading of RFID tags. The scan information is information indicating a scan result obtained by the wireless tag communication apparatus 1. The scan result includes information relating to reading of the RFID tag by the wireless tag communication apparatus 1. The information relating to the reading of the RFID tag includes tag information recorded in the RFID tag. The information relating to the reading of the RFID tag may also include information indicating the number of read RFID tags. The scan result includes information relating to radio waves from the wireless tag communication apparatus 1. The information relating to the radio waves includes information indicating strength of the radio waves and an irradiation time of the radio waves. The scan result is, for example, a label. The label is a numerical value indicating the scan result. The label may, for example, indicate a read count of RFID tags read by the wireless tag communication apparatus 1. The label may be a numerical value indicating strength of radio waves from the wireless tag communication apparatus 1. The label may be a numerical value indicating an irradiation time of the radio waves from the wireless tag communication apparatus 1. The label is a numerical value based on at least one of the read count, the strength of the radio waves, and the irradiation time of the radio waves. The label may also be a numerical value based on a combination of the read count, the strength of the radio waves, or the irradiation time of the radio waves. The scan result may also include information indicating a scan region.

The scan information includes positional information. The positional information is, for example, information relating to coordinates of the wireless tag communication apparatus 1. The coordinates include, for example, X, Y, and Z coordinates. The scan information may also include time information indicating a time at which the RFID tag is read by the wireless tag communication apparatus 1. The time at which the RFID tag is read is a time at which the radio waves are irradiated by the wireless tag communication apparatus 1. The time at which the radio waves are irradiated, for example, indicates a time at which the scanning is performed. The time at which the scanning is performed is also referred to as a scanning time. The server 2 manages the scan information of the plurality of wireless tag communication apparatuses 1 in the store X.

The server 2 stores user information relating to customers in the store X. The user information includes point information of the customers. The point information is a collection of point records generated for users. The point record includes, for example, a user ID and service points (described below). The user ID is, for example, information with which a customer can be uniquely identified as a member of the point service. The user ID may be information indicated by a membership code. The user ID is an example of user identification information. The service points are, for example, reward points granted to a user based on transaction payment. The service points may be earned, deducted, or lost in response to user actions, activities, or the like. The service points indicate the current amount of service points of the user. The service points are also simply referred to as points.

The server 2 may be a cloud server. The server 2 may manage inventory information of a plurality of stores. The server 2 is an example of an information processing apparatus.

The configuration of the wireless tag communication apparatus 1 will be described.

FIG. 2 is a diagram illustrating a configuration example of the external view of the wireless tag communication apparatus 1 according to the embodiment.

The wireless tag communication apparatus 1 illustrated in FIG. 2 is a handheld apparatus that is operated while being held by an operator. The wireless tag communication apparatus 1 illustrated in FIG. 2 is operated, for example, as a searching apparatus that searches for RFID tags or products to which RFID tags are attached.

The wireless tag communication apparatus 1 reads tag information or the like recorded in an RFID tag by communicating with the RFID tag.

The RFID tag is a wireless communication apparatus that operates in response to the radio waves (an output signal) from the wireless tag communication apparatus 1. The RFID tag includes a control device, a memory, a communication circuit, and an antenna. The RFID tag outputs a response signal including tag information recorded in its internal memory in response to a read command from the wireless tag communication apparatus 1. For example, the RFID tag is attached to a product such as a merchandise item or a component. For the RFID tag attached to a product, tag information including information with which the product is identified is recorded in the tag’s internal memory.

The wireless tag communication apparatus 1 according to the embodiment is operated by an operator. The wireless tag communication apparatus 1 is an apparatus that can communicate with an RFID tag while the wireless tag communication apparatus 1 is moving. For example, the wireless tag communication apparatus 1 is a handheld apparatus that is operated with a hand of the operator while the operator is moving. The wireless tag communication apparatus 1 may be mounted on a mobile body that is operated by the operator. The operator is an example of a user of the wireless tag communication apparatus 1.

The wireless tag communication apparatus 1 according to the embodiment reads an RFID tag attached to a product while changing a position and an orientation through an operation by the operator.

The wireless tag communication apparatus 1 reads the tag information recorded in the RFID tag by receiving the response signal from the RFID tag that is present within a reading region (scan region) of the wireless tag communication apparatus 1. Further, the wireless tag communication apparatus 1 also acquires information such as a received signal strength indicator (RSSI) value and a phase value from the response (received) signal from the RFID tag. The wireless tag communication apparatus 1 may store the tag information, the RSSI value, and the phase value obtained from the received signal along with information such as a position and an orientation of the wireless tag communication apparatus 1, as the reading result in the memory.

In the configuration example illustrated in FIG. 2, the wireless tag communication apparatus 1 includes the reader apparatus 10 and the information processing terminal 13. The reader apparatus 10 may be provided as the wireless tag communication apparatus 1. In this case, the wireless tag communication apparatus 1 serving as the reader apparatus 10 is operated with the information processing terminal 13, which is an external apparatus, set as a user interface.

The reader apparatus 10 includes a casing that has an RFID tag interface including an antenna and a communication control circuit. In the reader apparatus 10, the antenna is provided such that directivity is strongest in a direction of an arrow a in FIG. 2. Here, the direction of the arrow a is assumed to be the front (forward) direction of the wireless tag communication apparatus 1. It is assumed that the front direction of the wireless tag communication apparatus 1 is the orientation direction of the antenna.

The reader apparatus 10 includes a gripping portion 11 and a holding portion 12 in addition to a control system to be described below. The gripping portion 11 is a portion gripped by the operator. The holding portion 12 is configured with a fixture that holds the information processing terminal 13. The holding portion 12 holds the information processing terminal 13 such that a display screen of a display 14 of the information processing terminal 13 is appropriate for the operator gripping the gripping portion 11. The wireless tag communication apparatus 1 is operated by the operator gripping the gripping portion 11 with the information processing terminal 13 set in the holding portion 12.

The information processing terminal 13 includes the display 14 and an input panel 15. The display 14 and the input panel 15 are, for example, a display device with a touch panel. In the state where the information processing terminal 13 is set in the holding portion 12 of the reader apparatus 10, the operator can visually perceive a screen displayed on the display 14. The display 14 is an example of a display unit. In the state where the information processing terminal 13 is set in the holding portion 12 of the reader apparatus 10, an operation instruction given by the operator is input to the input panel 15.

The wireless tag communication apparatus 1 continuously reads RFID tags while being operated by the operator. For example, the operator changes a position of the wireless tag communication apparatus 1 including the antenna when the operator is moving with holding the gripping portion 11. The wireless tag communication apparatus 1 repeatedly performs the reading of RFID tags within the reading region, which is defined by the orientation of the antenna and the magnitude of the radio waves emitted from the antenna, while performing an estimation of its position.

The wireless tag communication apparatus 1 estimates its position using a self-estimation technique. For example, the wireless tag communication apparatus 1 estimates its position using a position estimation scheme that is employed in augmented reality (AR) techniques, and relies on an image captured by a camera. However, the scheme and the configuration for estimating the position of the wireless tag communication apparatus 1 are not limited to a specific scheme and configuration, as long as the position can be estimated even in an indoor environment.

A configuration of a control system in the wireless tag communication apparatus 1 according to the embodiment will be described.

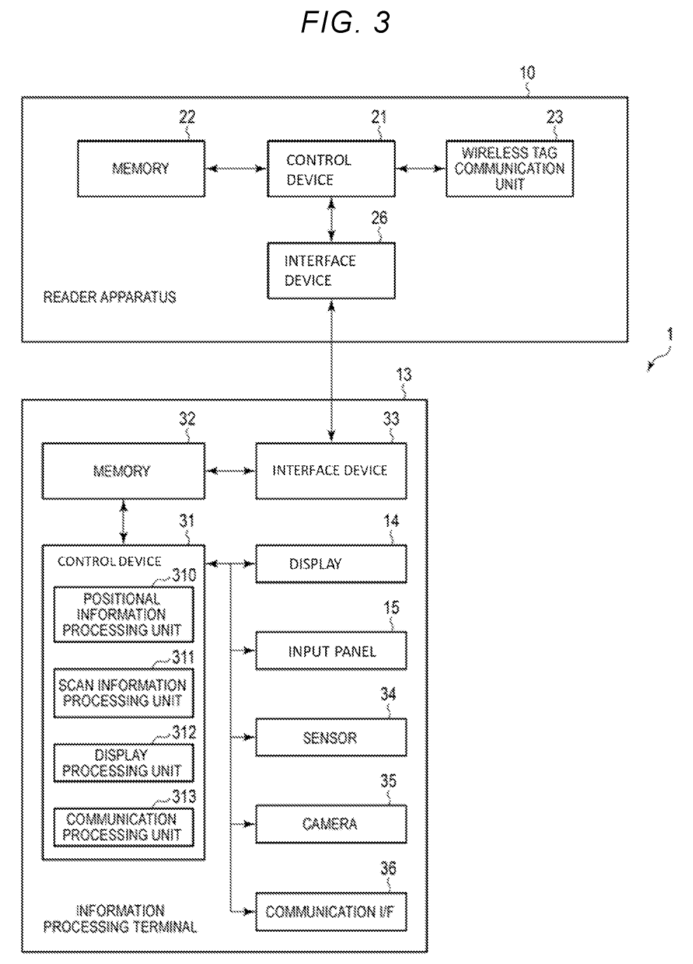

FIG. 3 is a block diagram schematically illustrating a first configuration example of the control system in the wireless tag communication apparatus 1 according to the embodiment.

In the configuration example illustrated in FIG. 3, the reader apparatus 10 serving as the wireless tag communication apparatus 1 is connected to the information processing terminal 13 as an external apparatus. The reader apparatus 10 serving as the wireless tag communication apparatus 1 includes a control device 21, a memory 22, a wireless tag communication unit 23, and an interface device 26.

The control device 21 controls each unit. The control device 21 includes, for example, a calculation circuit such as a central processing unit (CPU). The control device 21 implements control of each unit and various types of data processing by executing programs. The control device 21 may include an internal memory. The control device 21 performs various processes by executing programs stored in the memory 22 or the like. For example, the calculation circuit may be a CPU, graphics processing unit (GPU), an application specific integrated circuit (ASIC), or a field-programmable gate array (FPGA), but the embodiment is not limited thereto. The control device 21 is an example of a processing circuit that includes a calculation circuit.

The memory 22 includes various types of memory. For example, the memory 22 includes a memory such as a read only memory (ROM), a random access memory (RAM), or a nonvolatile memory (NVM). The ROM is a nonvolatile memory that is not rewritable. The ROM stores programs or the like executed by the control device 21. The RAM is a volatile memory that temporarily stores data. The RAM operates as a working memory or a buffer memory. The NVM is a rewritable nonvolatile memory. The NVM stores information such as control information, setting information, and processing results. The NVM of the memory 22 stores various programs required for the control device 21 to perform processes to be described below.

The wireless tag communication unit 23 is a communication device that configures an RFID interface for communication with RFID tags. The wireless tag communication unit 23 is a communication device that includes a communication control circuit and an antenna. Here, the wireless tag communication unit 23 may also be configured with a connection interface for connection with an external antenna.

In the wireless tag communication unit 23, the communication control circuit includes a control circuit for communicating with the RFID tag via the antenna. The communication control circuit causes the antenna to emit a transmission signal (radio waves) supplied with a set output value from the control device 21. The antenna outputs the transmission signal supplied from the communication control circuit as radio waves that the RFID tag can receive. The wireless tag communication unit 23 sets a range (reading region) in which the RFID tag can respond in accordance with an orientation of the antenna and the output value of the radio waves emitted from the antenna.

In the wireless tag communication unit 23, the communication control circuit not only outputs a transmission signal to the antenna but also supplies a signal received by the antenna as received data to the control device 21. The communication control circuit processes the response signal (received signal) received by the antenna from the RFID tag and supplies the processed response signal to the control device 21. For example, the communication control circuit supplies the control device 21 with the tag information included in the received signal from the RFID tag along with the RSSI value indicating the received signal strength and the phase value of the received signal.

The interface device 26 may correspond to an interface 33 included in the information processing terminal 13. For example, the interface device 26 may be connected by physical contact to an interface included in the information processing terminal 13, such as a universal serial bus (USB) interface or a LAN interface. The interface device 26 may be an interface that performs wireless communication for connection via a Bluetooth (registered trademark) interface or a Wi-Fi (registered trademark) interface.

The reader apparatus 10 serving as the wireless tag communication apparatus 1 has a power supply that provides operational power. In the handheld wireless tag communication apparatus 1, for example, a rechargeable battery is used as a power supply. The battery supplies power to each unit of the wireless tag communication apparatus 1 to operate each unit.

In the configuration example illustrated in FIG. 3, the information processing terminal 13 is set in the holding portion 12 of the reader apparatus 10 serving as the wireless tag communication apparatus 1. The information processing terminal 13 may be an apparatus including the display 14 and the input panel 15 and connected for communication to the reader apparatus 10 serving as the wireless tag communication apparatus 1. The information processing terminal 13 is, for example, a portable information processing terminal such as a smartphone or tablet personal computer (PC).

As illustrated in FIG. 3, the information processing terminal 13 includes a control device 31, a memory 32, an interface device 33, a sensor 34, a camera 35, the display 14, and the input panel 15.

The control device 31 performs control of each unit and data processing or the like. The control device 31 is, for example, a CPU. The control device 31 implements various operations by executing programs stored in the memory 32. The control device 31 is an example of a processing circuit that includes a calculation circuit.

The memory 32 stores scan information. The scan information is information indicating a scan result by the wireless tag communication apparatus 1. The scan information can include positional information, a label, and time information.

The memory 32 stores object data. The object data is data for displaying an object. The object is, for example, an object for visualizing a scan result by the wireless tag communication apparatus 1. The object is, for example, a virtual object. The scan result by the wireless tag communication apparatus 1 is an example of a scan result by the reader apparatus 10. The object indicates, for example, a region scanned by the wireless tag communication apparatus 1. The scanned region is also referred to as a scan region. The scan region corresponds to a reading region of the wireless tag communication apparatus 1. The scan region is, for example, set in accordance with a distance between a position of the wireless tag communication apparatus 1 and an RFID tag (which may be positioned on a shelf), an orientation of the antenna, and an output value of radio waves. An object may have any shape. For example, an object may have a shape that surrounds the scan region. An object may have a shape that surrounds merchandise items placed on a shelf within the scan region. Object data may include data indicating a plurality of objects associated with scan information. For example, object data may include data indicating a plurality of objects associated with values of labels. The object data may include data indicating different objects depending on the values of the labels. For example, the object data may include data indicating different objects associated with the values of the labels. The different objects may include objects with different display forms. The display forms include a size, a shape, color, density, brightness, luminance, a pattern, or flashing display. The object data may simply be referred to as "objects".

The interface device 33 is an interface for connection with the interface device 26 for communication. The interface device 33 may correspond to the interface device 26. For example, the interface device 33 is an interface such as a LAN, a USB, Bluetooth, or Wi-Fi.

The sensor (or a sensor group) 34 includes a sensor that detects a motion of the information processing terminal 13. For example, the sensor 34 is an inertial measurement unit (IMU). The sensor 34 may include an accelerometer, a gyroscope, or a geomagnetic (azimuth) sensor. The sensor 34 may include a plurality of types of sensors. The sensor 34 may also include a position detection sensor that detects a position. In this case, the sensor 34 is an example of a position detection sensor. Some or all of the sensors serving as the above-described sensor 34 may be included in the reader apparatus 10.

The camera 35 captures an image. The camera 35 changes an imaging direction in accordance with an orientation of the reader apparatus 10, with the information processing terminal 13 set in the reader apparatus 10. For example, the imaging direction of the camera 35 may be set to match an orientation of the antenna of the wireless tag communication unit 23 included in the reader apparatus 10.

An image captured by the camera 35 is used to estimate a position of the information processing terminal 13 (and thus a position of the wireless tag communication apparatus 1 configured with the reader apparatus 10 in which the information processing terminal 13 is set). The camera 35 is an example of the position detection sensor. For example, the control device 31 of the information processing terminal 13 estimates its position based on the images captured by the camera 35 in accordance with the position estimation scheme that is employed in augmented reality (AR) techniques.

The communication interface device 36 includes various interfaces that connect the information processing terminal 13 to be able to communicate with another electronic apparatus via the network NW in accordance with a predetermined communication protocol. For example, the information processing terminal 13 communicates with the server 2 via the communication interface device 36. The communication interface device 36 may be an interface for wired communication or an interface for wireless communication.

The display 14 and the input panel 15 included in the information processing terminal 13 are connected to the control device 21 via an internal interface. The display 14 is a device that displays information. For example, the display 14 displays a display screen instructed by the control device 21. The input panel 15 is a device used for the operator to input an operation instruction or the like. The input panel 15 supplies the control device 21 with information indicating the content instructed by the operator.

A hardware configuration of the wireless tag communication apparatus 1 is not limited to the above-described configuration. The wireless tag communication apparatus 1 allows for the omission and modification of the above-described constituent element and addition of a new constituent element, as appropriate.

Each unit implemented by the above-described control device 31 will be described.

The control device 31 implements a positional information processing unit 310, a scan information processing unit 311, a display processing unit 312, and a communication processing unit 313. Each unit implemented in the control device 31 can also be referred to as a respective function. Each unit implemented in the control device 31 can also be considered to be implemented in a control unit that includes the control device 21 and memory 32.

The positional information processing unit 310 performs a position estimation process of estimating a position of the wireless tag communication apparatus 1. The positional information processing unit 310 estimates the position of the wireless tag communication apparatus 1 using a position estimation technique. The position of the wireless tag communication apparatus 1 can be interpreted as the position of the information processing terminal 13. The position of the wireless tag communication apparatus 1 is an example of a position of the user. The positional information processing unit 310 estimates the position of the wireless tag communication apparatus 1 based on a camera image captured by the camera 35 in accordance with the position estimation scheme that is employed in AR techniques. The positional information processing unit 310 may also estimate the position of the wireless tag communication apparatus 1 in accordance with the position estimation scheme based on sensor data acquired from the sensor 34. The sensor data may include, for example, acceleration data and angular velocity data. The positional information processing unit 310 may estimate the position of the wireless tag communication apparatus 1 based on both the camera image and the sensor data. The positional information processing unit 310 acquires positional information of the wireless tag communication apparatus 1 indicating the position of the wireless tag communication apparatus 1 based on the position estimation process. The positional information is, for example, coordinate information indicated by X, Y, and Z coordinates. The positional information of the wireless tag communication apparatus 1 is an example of positional information of the user.

The scan information processing unit 311 acquires scan information regarding scanning performed by the reader apparatus 10. The scan information processing unit 311 acquires the scan information from the reader apparatus 10 via the interface device 33. The scan information processing unit 311 stores the scan information in the memory 32.

The display processing unit 312 displays an object on the camera image based on the positional information of the user and the scan information. The display processing unit 312 displays an image in which the object is overlapped on or combined with the camera image on the display 14 in accordance with the AR technique. For example, the display processing unit 312 may perform spatial recognition based on the camera image with the AR technique. The display processing unit 312 may overlay or combine an object based on a space recognized in the camera image. The display processing unit 312 displays an object in the scan region of the camera image based on the scan information. For example, The display processing unit 312 may display an object surrounding the scan region. For example, The display processing unit 312 may display an object to fill the scan region.

The display processing unit 312 may display the different objects on the display 14 in accordance with the scan information. The display processing unit 312 may display the different objects on the display 14 in accordance with the values of the labels. For example, the display processing unit 312 may display the different objects in accordance with a read count of tags read by the reader apparatus 10. The display processing unit 312 may change a size of the object according to the read count. For example, the display processing unit 312 may display an object with a larger size as the read count is larger. The display processing unit 312 may change a color density of the object in accordance with the read count. The display processing unit 312 may display an object with a higher color density as the read count is higher. The display processing unit 312 may reduce the size of the object as the read count decreases. The display processing unit 312 may reduce the density of the object as the read count decreases. The display processing unit 312 may change the size of the object based on the fact that the read count exceeds a predetermined value. The display processing unit 312 may change the density of the object based on the fact that the read count exceeds the predetermined value. The display processing unit 312 may change the shape of the object in accordance with the read count.

The display processing unit 312 may display the different objects based on an irradiation time of the radio waves from the reader apparatus 10. The display processing unit 312 may change the size of the object according to the irradiation time of the radio waves. For example, the display processing unit 312 may display a larger object when the irradiation time of the radio waves is longer. The display processing unit 312 may change the density of the object in accordance with the irradiation time of the radio waves. The display processing unit 312 may display an object with color of high density when the irradiation time of the radio waves is longer. The display processing unit 312 may reduce the size of the object as the irradiation time of the radio waves decreases. The display processing unit 312 may reduce the density of the object as the irradiation time of the radio waves decreases. The display processing unit 312 may change the size of the object based on the fact that the irradiation time of the radio waves exceeds a predetermined value. The display processing unit 312 may change the density of the object based on the fact that the irradiation time of the radio waves exceeds the predetermined value. The display processing unit 312 may change the shape of the object in accordance with the irradiation time of the radio waves.

The display processing unit 312 may display the different objects in accordance with the strength of the radio waves by the reader apparatus 10 similarly.

The display processing unit 312 may change a display mode of the object based on the time information. For example, the display processing unit 312 may display the different objects in accordance with a time elapsed from a scan time. The display processing unit 312 may hide the object when the time elapsed from the scan time exceeds a predetermined time. The hiding of the object includes removing the display of the object. For example, the display processing unit 312 may display an object with a smaller size as the time elapsed from the scan time is longer. The display processing unit 312 may display an object with lower color density as the time elapsed from the scan time is longer.

The display processing unit 312 may display an object on the camera image based on scan history information. The scan history information indicates a history of past scan information. For example, the scan history information indicates a history of scan information for a predetermined time period from a current time. The scan information for the predetermined time period from the current time is the scan information from a time traced back from the current time by the predetermined time to the current time. For example, the scan information for the predetermined time period from the current time may be the scan information from five hours prior to the current time up to the current time. In this case, the scan history information includes the scan information of scanning performed from five hours ago to the current time. The scan history information may also include scan information from another wireless tag communication apparatus 1. The scan history information may include scan information from the plurality of wireless tag communication apparatuses 1. The display processing unit 312 may display on the display 14 an image in which an object indicating a scan result scanned by another wireless tag communication apparatus 1 is overlapped on or combined with the camera image based on the scan history information. The display processing unit 312 may display on the display 14 an image in which objects indicating scan results scanned by the plurality of wireless tag communication apparatuses 1 are overlapped on or combined with the camera image.

The communication processing unit 313 outputs data to the server 2 via the communication interface device 36. For example, the communication processing unit 313 outputs the scan information to the server 2. The communication processing unit 313 acquires data from the server 2 via the communication interface device 36. For example, the communication processing unit 313 acquires scan history information relating to past scanning from the server 2. The communication processing unit 313 may output a scan history request command to request the scan history information from the server 2. The communication processing unit 313 may acquire the scan history information in response to the scan history request command.

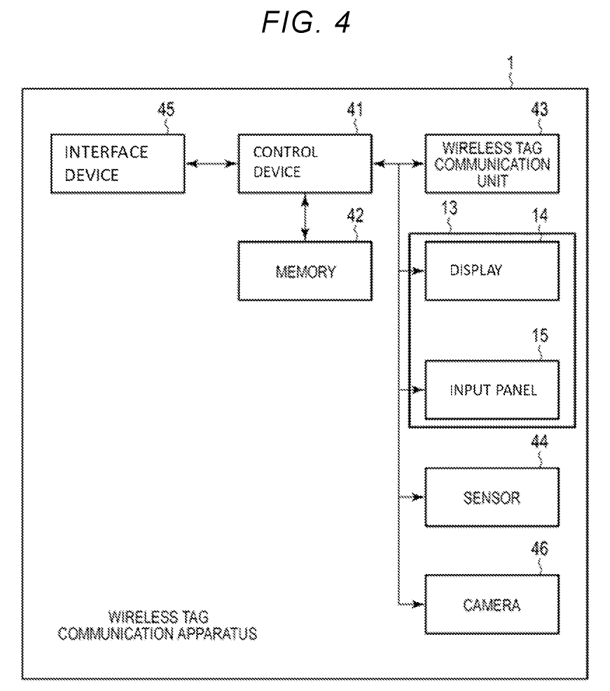

FIG. 4 is a block diagram schematically illustrating a second configuration example of the control system in the wireless tag communication apparatus 1 according to the embodiment. The wireless tag communication apparatus 1 may have a configuration of FIG. 4 instead of the wireless tag communication apparatus 1 illustrated in FIG. 3.

In the configuration example illustrated in FIG. 4, the wireless tag communication apparatus 1 includes a control device 41, a memory 42, a wireless tag communication unit 43, a sensor 44, a communication interface (I/F) 45, a camera 46, the display 14, and the input panel 15.

The control device 41 controls each unit. The control device 41 includes, for example, a calculation circuit such as a CPU. The control device 41 implements control of each unit and various types of data processing by executing programs. The control device 41 may include an internal memory. The control device 41 performs various processes by executing programs stored in the memory 42 or the like.

The control device 41 implements the same functions as the control device 31. The control device 41 can implement functions similar to those of the positional information processing unit 310, the scan information processing unit 311, the display processing unit 312, and the communication processing unit 313. The control device 41 is an example of a processing circuit that includes a calculation circuit.

The memory 42 includes various types of memory. For example, the memory 42 includes a memory such as a ROM, a RAM, or an NVM. The ROM is a nonvolatile memory that is not rewritable. The ROM stores programs or the like executed by the control device 41. The RAM is a volatile memory that temporarily stores data. The RAM operates as a working memory or a buffer memory.

The NVM of the memory 42 is a rewritable nonvolatile memory. The memory 42 stores information such as control information, setting information, and processing results in the NVM. The memory 42 stores various programs required for the control device 41 to perform processes to be described below in the NVM. For example, the memory 42 stores an operation support program outputting information for supporting an operation of the device, by the operator in the NVM. The memory 42 stores an evaluation reference value used for the operation support program to evaluate an operation of the device, in the NVM.

As in the memory 32, the memory 42 stores the scan information. As in the memory 32, the memory 42 stores object data.

The wireless tag communication unit 43 is a communication device included in the RFID interface communicating with an RFID tag. The wireless tag communication unit 43 is, for example, a communication device that includes a communication control circuit and an antenna. Here, the wireless tag communication unit 43 may be configured with a connection interface connected to an external antenna.

In the wireless tag communication unit 43, the communication control circuit includes a control circuit that communicates with an RFID tag via the antenna. The communication control circuit causes the antenna to emit a transmission signal (radio waves) supplied with a set output value from the control device 41. The antenna outputs the transmission signal supplied from the communication control circuit as radio waves that the RFID tag can receive. The wireless tag communication unit 43 sets a range (reading region) in which the RFID tag can respond in accordance with an orientation of the antenna and an output value of the radio waves emitted from the antenna.

In the wireless tag communication unit 43, the communication control circuit not only outputs a transmission signal to the antenna but also supplies a signal received by the antenna as received data to the control device 41. The communication control circuit processes the response signal (received signal) received by the antenna from the RFID tag and supplies the processed response signal to the control device 41. For example, the communication control circuit supplies the control device 41 with the tag information included in the received signal from the RFID tag along with the RSSI value and the phase value of the received signal.

The sensor (sensor group) 44 includes a sensor similar to the sensor (sensor group) 34.

The communication interface 45 includes various interfaces that connect the wireless tag communication apparatus 1 to be able to communicate with another electronic apparatus via the network NW in accordance with a predetermined communication protocol. For example, the information processing terminal 13 communicates with the server 2 via the communication interface 45. The communication interface 45 may be an interface for wired communication or an interface for wireless communication.

The camera 46 captures an image. An imaging direction of the camera 46 changes in accordance with an orientation of the wireless tag communication apparatus 1. For example, the imaging direction in which the camera 46 performs imaging may be set to match an orientation of the antenna of the wireless tag communication unit 43. An image captured by the camera 46 is used to estimate a position of the wireless tag communication apparatus 1. The camera 46 is an example of a position detection sensor. For example, the wireless tag communication apparatus 1 estimates its position based on the image captured by the camera 46 in accordance with a position estimation scheme that is employed in augmented reality (AR) techniques. The wireless tag communication device 1 detects the AR marker with a camera, acquires the ID, position, and orientation of the AR marker, and estimates the position of the terminal.

The wireless tag communication apparatus 1 has a power supply that provides operational power. In the handheld wireless tag communication apparatus 1, for example, a rechargeable battery is used as a power supply. The battery supplies power to each unit of the wireless tag communication apparatus 1 to operate each unit. The wireless tag communication apparatus 1 may be configured such that the camera is replaced with a device that identifies a position of the wireless tag communication apparatus 1.

A hardware configuration of the wireless tag communication apparatus 1 is not limited to the above-described configuration. The wireless tag communication apparatus 1 allows for the omission and modification of the above-described constituent element and addition of a new constituent element, as appropriate.

The scan information will be described.

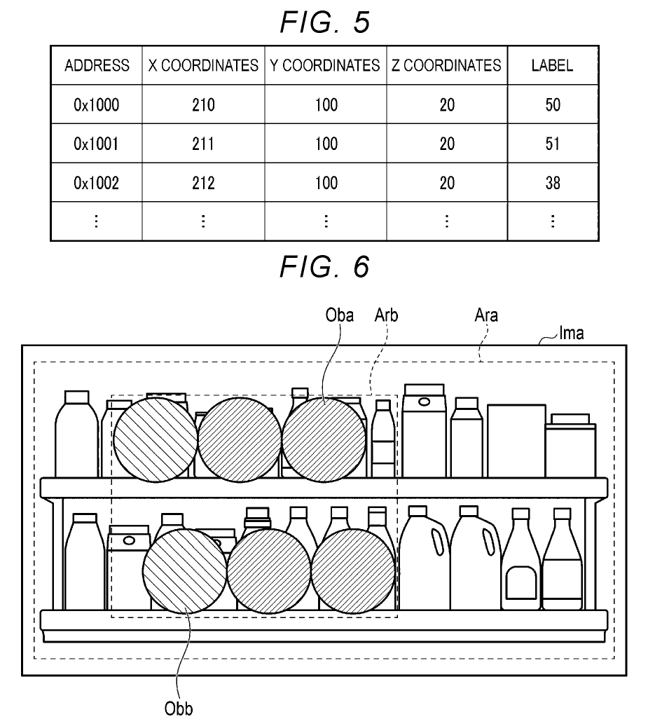

FIG. 5 is a diagram illustrating a data structure of scan information according to the embodiment.

FIG. 5 illustrates an example of a data structure of scan information stored in the memory 32. The scan information indicates a scan result from the wireless tag communication apparatus 1. The scan information includes positional information and a label. The positional information indicates positional information of the wireless tag communication apparatus 1. The positional information includes information regarding X, Y, and Z coordinates. The label indicates a numerical value representing the scan result from the wireless tag communication apparatus 1. The label indicates, for example, at least one of a numerical value representing a read count of RFID tags read by the wireless tag communication apparatus 1, a numerical value representing the strength of radio waves from the wireless tag communication apparatus 1, and a numerical value representing an irradiation time of radio waves from the wireless tag communication apparatus 1. The label may represent a numerical value based on a combination of a read count of RFID tags, strength of the radio waves, and an irradiation time of the radio waves. For example, the label indicates that the read count of RFID tags is higher as the numerical value is higher. For example, the label indicates that the strength of the radio waves is higher as the numerical value is higher. The label indicates that the irradiation time of the radio waves is longer as the numerical value is higher. The label may indicate that a read ratio at which an RFID tag is read is higher as the numerical value is higher.

The scan information includes an address. The address is an address of a memory. The address indicates a position at which data is stored in the memory.

For example, at the address "0x1000", positional information "X coordinate: 210", "Y coordinate: 100", "Z coordinate: 20", and label "50" are stored. The wireless tag communication apparatus 1 performs scanning at positional information "(X, Y, Z) = (210, 100, 20)" and the scan result is the label "50".

### Display Example

An example of an object display image displayed on the display 14 of the wireless tag communication apparatus 1 will be described.

FIG. 6 is a schematic diagram illustrating an example of an object display image displayed on the wireless tag communication apparatus 1 according to the embodiment.

FIG. 6 illustrates an object display image Ima. The object display image Ima is an image displayed on the display 14 when scanning is performed by the user of the wireless tag communication apparatus 1. The user scans a shelf where merchandise items are displayed by pointing the wireless tag communication apparatus 1 at the shelf. In the following description, it is assumed that the user is using the wireless tag communication apparatus 1 illustrated in FIG. 3. The shelf where the merchandise items are displayed is also referred to as a merchandise item shelf.

The object display image Ima includes a camera image display region Ara and an object display region Arb. The camera image display region Ara is a region where the camera image captured by the camera 35 is displayed. The camera 35 can capture an image of the shelf included in the imageable region in a direction in which the wireless tag communication apparatus 1 is pointed.

The object display region Arb is a region where objects are displayed. For example, the control device 31 displays objects in the object display region Arb based on the scan information. The object display region Arb corresponds to the scan region of the wireless tag communication apparatus 1. In this example, the control device 31 displays the object so as to fill the merchandise items located in the object display region Arb based on the scan information. For example, the control device 31 may display the objects overlapped on or combined with the camera image.

An object Oba is an example of an object displayed based on the positional information and the label indicated in the scan information. For example, it is assumed that object Oba is an object based on positional information "(X, Y, Z) = (210, 100, 20)" and the label "50". Based on the object data, the control device 31 displays an object in a display form corresponding to the label "50" at a position of the camera image corresponding to a scan region from positional information "(X, Y, Z) = (210, 100, 20)", as the object Oba. The control device 31 may display a plurality of objects so that the scan region is filled. The object display region Arb may display objects indicating scan results from a plurality of scan positions of the wireless tag communication apparatus 1. The object display region Arb may include a plurality of objects with different display forms in accordance with the value of the label. For example, a case where the object Oba corresponds to the label "50" and an object Obb corresponds to label "30" will be described. The control device 31 may display the object Oba in darker color than the object Obb. The control device 31 may also display object Oba with a smaller size than object Obb.

In the example of FIG. 6, a plurality of objects are displayed in the object display region Arb, but the display form of the objects is not limited thereto. For example, the control device 31 may display one object surrounding the scan region corresponding to the positional information based on the positional information and the label indicated in the scan information. The control device 31 may also partially change the display form of one object based on the label. For example, the control device 31 may display a part of the scan region corresponding to a high value of the label in high density color. The control device 31 may display the part of the scan region corresponding to a low value of the label in low density color.

According to this example, the wireless tag communication apparatus 1 can visualize scan results by displaying objects in the scan region. For example, the wireless tag communication apparatus 1 can visualize positions at which many RFID tags are read by displaying different objects depending on the read count of tags. The wireless tag communication apparatus 1 can visualize positions at which RFID tags are likely to be read in large numbers by displaying the different objects in accordance with the irradiation time of radio waves by the reader apparatus 10. Therefore, the user of the wireless tag communication apparatus 1 can visually confirm how far on the merchandise item shelf the scanning has been performed. Thus, the wireless tag communication apparatus 1 can visualize the scan results for the user.

### Processing Example

A process in the information processing system S will be described.

A processing procedure to be described below is merely exemplary, and each process may be modified, as necessary. Depending on the embodiment, the processing procedure to be described below may be appropriately omitted, substituted, or supplemented.

In the following description in which the information processing terminal 13 is focused on, the information processing terminal 13 may be interpreted as the control device 31. Similarly, in the description in which the server 2 is focused on, the server 2 may be interpreted as a control device of the server 2.

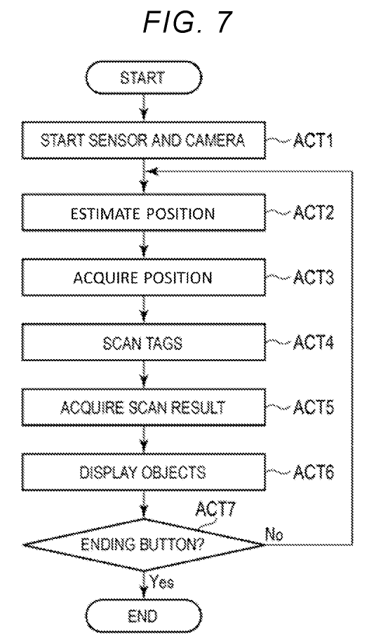

FIG. 7 is a flowchart illustrating an example of an operation of the wireless tag communication apparatus 1 according to the embodiment. The wireless tag communication apparatus 1 is assumed to be the wireless tag communication apparatus illustrated in FIG. 3.

Hereinafter, it is assumed that the user of the wireless tag communication apparatus 1 scans a shelf on which merchandise items are displayed in the store X using the reader apparatus 10. The user, for example, points the reader apparatus 10 toward the shelf on which the merchandise items are displayed and emits radio waves from the reader apparatus 10. For example, the user is a store staff member who performs an inventory task in the store X.

The control device 31 of the information processing terminal 13 starts the sensor 34 and the camera 35 (ACT1). In ACT1, for example, the control device 31 starts the sensor 34 and the camera 35 in response to an operation by a user. The operation by the user is, for example, an input of a scan start instruction indicating the start of scanning.

The control device 31 estimates the position of the wireless tag communication apparatus 1 (ACT2). ACT2 may also be a process performed by the positional information processing unit 310 implemented by the control device 31. In ACT2, for example, the control device 31 acquires a camera image from the camera 35. The control device 31 acquires sensor data from the sensor 34. The control device 31 estimates the position of the wireless tag communication apparatus 1 using a position estimation scheme used in the AR technique based on the camera image and the sensor data.

The control device 31 acquires the position of the wireless tag communication apparatus 1 (ACT3). ACT3 may also be a process performed by the positional information processing unit 310 implemented by the control device 31. In ACT3, for example, the control device 31 acquires positional information indicating the position of the wireless tag communication apparatus 1 estimated by the position estimation scheme. The control device 31 acquires, for example, information regarding the X, Y, and Z coordinates indicating the position of the wireless tag communication apparatus 1. The control device 31 stores the positional information in the memory 32.

The control device 31 scans the RFID tags of the merchandise items displayed on the shelf (ACT4). In ACT4, for example, the control device 31 outputs a response request (read command) as an output signal with a predetermined output value via the wireless tag communication unit 23. The wireless tag communication unit 23 receives received (response) signals output by the RFID tags within the scan region. When the wireless tag communication unit 23 receives the signals from the RFID tags, the wireless tag communication unit 23 extracts the tag information indicated by the received signals and supplies the extracted tag information to the control device 31.

The control device 31 acquires the scan results (ACT5). ACT5 may also be a process performed by the scan information processing unit 311 implemented by the control device 31. In ACT5, for example, the control device 31 acquires the read count of the tags as a scan result based on the tag information. The control device 31 may also acquire the irradiation time of the radio waves by the wireless tag communication unit 23 as the scan result. The control device 31 may also acquire the strength of the radio waves by the wireless tag communication unit 23 as the scan result. The control device 31 stores the scan result as scan information in the memory 32. The control device 31 may also store the labels based on the scan result in the memory 32.

The control device 31 displays the objects on the display 14 based on the scan information (ACT6). ACT6 may also be a process performed by the display processing unit 312 implemented by the control device 31. In ACT6, for example, the control device 31 determines the scan region based on the positional information. The control device 31 generates an image for displaying the object in the scan region based on the label. For example, the control device 31 displays on the display 14 an image in which the objects are overlapped or combined at a position corresponding to the scan region of the camera image acquired from the camera 35.

The control device 31 may display an object associated with the value of the label based on the object data at the position corresponding to the scan region. The control device 31 may display the different objects on the display 14 in accordance with the label. For example, the control device 31 may display the different objects in accordance with the read count of the tags read by the reader apparatus 10. The display processing unit 312 may also display the different objects depending on the irradiation time of the radio waves by the reader apparatus 10.

The control device 31 may change a display mode of the object based on the time information included in the scan information. For example, the control device 31 may display the different objects depending on the time elapsed from the scan time. When the time elapsed from the scan time exceeds a predetermined time, the control device 31 may change the display form of the object. The changing of the display form includes hiding the object.

The control device 31 determines whether an ending button for ending the scanning is selected (ACT7). In ACT7, for example, the control device 31 determines whether the ending button is selected by the user. The selecting of the ending button corresponds to an input of a scan ending instruction. The user inputs the scan ending instruction via the input panel 15. For example, the user may select the ending button displayed on the display 14.

When the ending button is selected (YES in ACT7), the process ends. When the ending button is not selected (NO in ACT7), the process returns from ACT7 to ACT2.

According to this example, the wireless tag communication apparatus 1 can acquire the positional information of the user, acquire the scan information regarding the scanning performed by the reader apparatus 10, and display the objects on the camera image based on the positional information of the user and the scan information. For example, the wireless tag communication apparatus 1 can determine the scan region of the reader apparatus 10 by estimating the position of the wireless tag communication apparatus 1. The wireless tag communication apparatus 1 can visualize the scan results by displaying the objects for visualizing the scan result in a region corresponding to the scan region of the camera image. Therefore, the user of the wireless tag communication apparatus 1 can visually confirm how far on the merchandise item shelf the scanning has been performed. Accordingly, the wireless tag communication apparatus 1 can visualize the scan results by the user.

The wireless tag communication apparatus 1 can display different objects based on the scan results. For example, by displaying different objects according to the read count of the tags, the wireless tag communication apparatus 1 can visualize positions where many RFID tags have been read. Additionally, the wireless tag communication apparatus 1 can visualize positions at which the RFID tags are likely to be read many times by displaying different objects in accordance with the irradiation time of the radio waves by the reader apparatus 10. As a result, the user of the wireless tag communication apparatus 1 can visually confirm at which positions on the merchandise item shelf many tags are read. The user can also recognize which positions are to be scanned on the merchandise item shelf. In this way, the wireless tag communication apparatus 1 can visualize the scan results by the user. For example, by visualizing the scan results, the user can recognize that a region where reading is sufficiently performed is a region where the inventory task is completed, while a region where reading is insufficient is a region where the inventory task is necessary. Thus, the wireless tag communication apparatus 1 can improve the efficiency of inventory tasks.

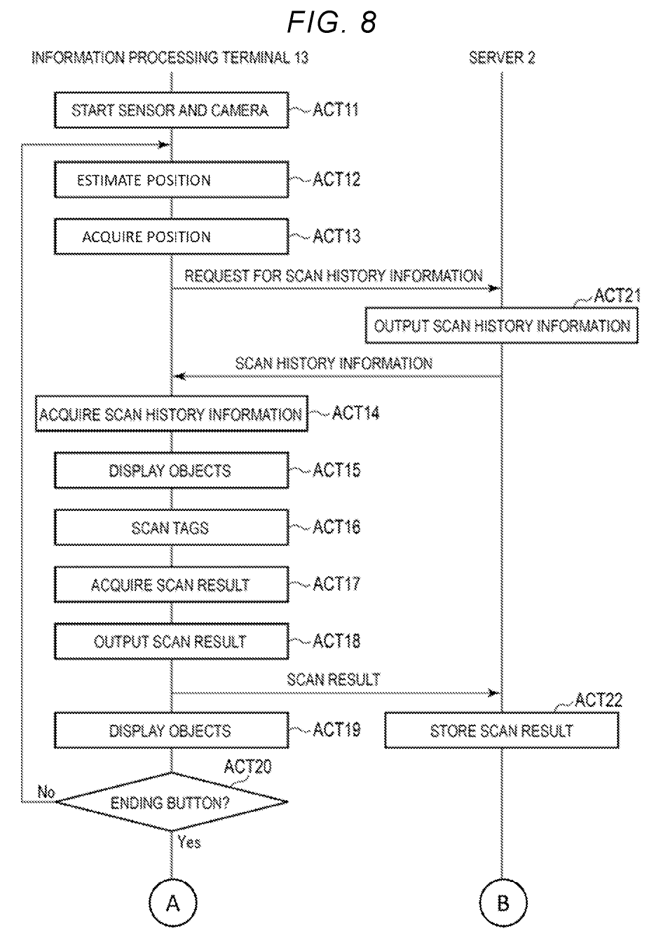

FIG. 8 is a sequence diagram illustrating another example of the operation of the wireless tag communication apparatus 1 according to the embodiment.

In the example of FIG. 8, the display 14 of the wireless tag communication apparatus 1 displays objects indicating the scan results of scanning performed in the past. The scanning performed in the past includes scanning performed in the past by the wireless tag communication apparatus 1. The scanning performed in the past also includes scanning performed in the past by a wireless tag communication apparatus different from the wireless tag communication apparatus 1. The scanning performed in the past includes scanning performed in the past by a plurality of wireless tag communication apparatuses. The scan results of the scanning performed in the past are assumed to be stored as scan history information in the server 2.

Hereinafter, as in the example of FIG. 7, it is assumed that the user of the wireless tag communication apparatus 1 scans the shelf on which merchandise items are displayed in the store X using the reader apparatus 10. For example, the user points the reader apparatus 10 toward the shelf on which the merchandise items are displayed and emits radio waves from the reader apparatus 10.

The control device 31 of the information processing terminal 13 starts the sensor 34 and the camera 35, as in ACT1 (ACT11). In ACT11, for example, the control device 31 starts the sensor 34 and the camera 35 in response to an operation by the user.

As in ACT2, the control device 31 estimates the position of the wireless tag communication apparatus 1 (ACT12). ACT12 may also be a process performed by the positional information processing unit 310 implemented by the control device 31.

As in ACT3, the control device 31 acquires the position of the wireless tag communication apparatus 1 (ACT13). ACT13 may also be a process performed by the positional information processing unit 310 implemented by the control device 31. The control device 31 stores the positional information in the memory 32.

The control device 31 requests scan history information from the server 2. This process may also be performed by the communication processing unit 313 implemented by the control device 31. For example, the control device 31 outputs a scan history information request command to the server 2. The scan history information request command may be a command for requesting the scan history information corresponding to a predetermined time period from the current time. For example, the scan history information request command may be a command for requesting the scan history information for the past five hours from the current time.

The server 2 acquires the scan history information request command from the information processing terminal 13. Based on the scan history information request command, the server 2 outputs the scan history information to the information processing terminal 13 (ACT21). In ACT21, for example, the server 2 outputs the scan history information indicating the scan results of the scanning performed in the past and stored in the memory to the information processing terminal 13.

The control device 31 of the information processing terminal 13 acquires the scan history information from the server 2 (ACT14). ACT14 may also be a process performed by the communication processing unit 313 implemented by the control device 31. The control device 31 may store the scan history information in the memory 32.

The control device 31 displays the objects on the display 14 based on the scan history information (ACT15). ACT15 may also be a process performed by the display processing unit 312 implemented by the control device 31. In ACT15, for example, the control device 31 determines the scan region based on the positional information in the scan history information. The control device 31 generates an image for displaying the objects indicating the scan history in the scan region, based on the labels of the scan history information. For example, the control device 31 displays on the display 14 an image in which the objects indicating the scan history are overlapped or combined at the position corresponding to the scan region of the camera image acquired from camera 35. The control device 31 may also display the objects associated with the values of the labels at the positions corresponding to the scan region based on the object data. The control device 31 may display the different objects on the display 14 in accordance with the labels. For example, the control device 31 may display the different objects in accordance with the read count of the tags indicated by the scan history information. The display processing unit 312 may also display the different objects in accordance with the irradiation time of the radio waves indicated by the scan history information.

The control device 31 may change the display mode of the object based on the time information included in the scan history information. For example, the control device 31 may display the different objects in accordance with the time elapsed from the scan time. When the time elapsed from the scan time exceeds the predetermined time, the control device 31 may change the display form of the objects.

As in ACT4, the control device 31 scans the RFID tags of the merchandise items displayed on the shelf (ACT16).

As in ACT5, the control device 31 acquires the scan results (ACT17). ACT17 may also be a process performed by the scan information processing unit 311 implemented by the control device 31. In ACT17, for example, the control device 31 acquires the read count of the tags as a scan result based on the tag information. The control device 31 may also acquire the irradiation time of the radio waves by the wireless tag communication unit 23 as the scan result. The control device 31 may also acquire the strength of the radio waves by the wireless tag communication unit 23 as the scan result. The control device 31 stores the scan result as scan information in the memory 32. The control device 31 may also store labels based on the scan result in the memory 32.

The control device 31 outputs the scan information indicating the scan result to the server 2 (ACT18). ACT18 may also be a process performed by the communication processing unit 313 implemented by the control device 31. In ACT18, for example, the control device 31 may output the scan information to the server 2 each time a scan result is acquired.

The server 2 acquires scan information from the information processing terminal 13. The server 2 stores the scan information in the memory (ACT22).

As in ACT6, the control device 31 displays the objects on the display 14 based on the scan information (ACT19). ACT19 may also be a process performed by the display processing unit 312 implemented by the control device 31. In ACT19, for example, the control device 31 displays on the display 14 an image in which the objects are overlapped or combined at the position corresponding to the scan region of the camera image acquired from camera 35.

The control device 31 may also display the objects associated with the values of the labels at the positions corresponding to the scan region based on the object data. The control device 31 may display the different objects on the display 14 in accordance with the labels. For example, the control device 31 may display the different objects in accordance with the read count of the tags read by the reader apparatus 10. The display processing unit 312 may also display the different objects in accordance with the irradiation time of the radio waves by the reader apparatus 10.

The control device 31 may change the display mode of the object based on the time information included in the scan information. For example, the control device 31 may display the different objects in accordance with the time elapsed from the scan time. When the time elapsed from the scan time exceeds the predetermined time, the control device 31 may change the display form of the objects.

As in ACT7, the control device 31 determines whether the ending button for ending the scanning is selected (ACT20).

When the ending button is selected (YES in ACT20), the process ends. When the ending button is not selected (NO in ACT20), the process returns from ACT20 to ACT12.

According to this example, the wireless tag communication apparatus 1 can acquire the scan history information regarding past scanning and display the objects, based on the scan history information, on the camera image. For example, the wireless tag communication apparatus 1 can display the objects on the camera image for visualizing the scan results of the scanning performed in the past by the wireless tag communication apparatus 1. Therefore, the user of the wireless tag communication apparatus 1 can visually confirm how far on the merchandise item shelf the scanning has been performed in the past. The wireless tag communication apparatus 1 can display on the camera image the objects for visualizing the scan results of the scanning performed by another wireless tag communication apparatus. Therefore, the user of the wireless tag communication apparatus 1 can visually confirm how far on the merchandise item shelf the scanning has been performed by another user. Accordingly, the user of the wireless tag communication apparatus 1 can recognize a portion of the merchandise item shelf already scanned and can easily recognize which position has to be scanned in the merchandise item shelf. Therefore, the information processing system S can share the scan results by the plurality of wireless tag communication apparatuses and prevent duplication of inventory tasks. Accordingly, the wireless tag communication apparatus 1 can improve efficiency of the inventory tasks.

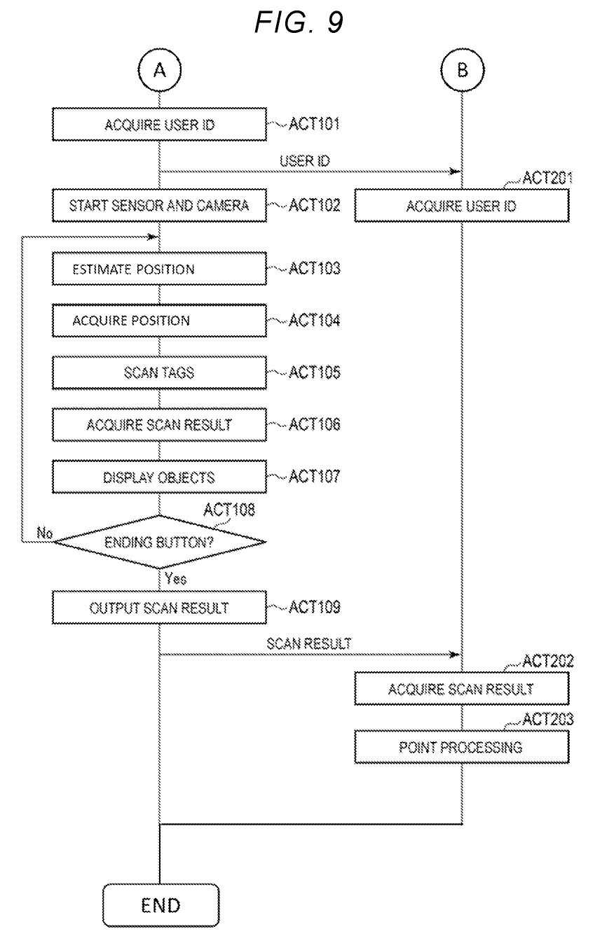

FIG. 9 is a sequence diagram illustrating still another example of the operation of the wireless tag communication apparatus 1 according to the embodiment.

In the example of FIG. 9, it is assumed that a customer in the store X scans a shelf on which merchandise items are displayed using the reader apparatus 10. In this example, the user of the wireless tag communication apparatus 1 is a customer of the store X. The customer is expected to receive a reward such as points based on the result obtained by scanning the shelf on which the merchandise items are displayed using the reader apparatus 10. For example, the reward may be service points, but the embodiment is not limited thereto. The reward may also be a coupon, a discount ticket, or the like.

The information processing terminal 13 is described as being loaned to a customer from the store X, but the embodiment is not limited thereto. For example, the information processing terminal 13 may be a smartphone or a tablet terminal carried by the customer. In this case, it is assumed that the smartphone or the tablet terminal of the customer is associated with the reader apparatus 10. It is assumed that the information processing terminal 13 includes a card reader that reads a membership card.

In the following description, as in the example of FIG. 7, the user (customer) of the wireless tag communication apparatus 1 points the reader apparatus 10 toward the shelf on which merchandise items are displayed and emits radio waves from the reader apparatus 10.

The control device 31 of the information processing terminal 13 acquires a user ID of the customer (ACT101). In ACT101, for example, the control device 31 displays a membership code request message for prompting the customer to enter a membership code on the display 14. For example, the membership code request message may include a message such as "Please scan your membership card." The membership code request message may be at least one of text data, image data, audio data, and video data. The customer scans her or his membership card via a card reader (not illustrated). The control device 31 may obtain the membership code of the customer via a camera or the like. The membership code may be the membership code recorded on the membership card or an image that can be displayed on a user terminal or the like. The control device 31 acquires the membership code based on a code symbol in which the membership code is recorded. The control device 31 may store the membership code as a user ID in the memory 32. The control device 31 outputs the user ID to the server 2.

The server 2 acquires the user ID from the information processing terminal 13 (ACT201).

As in ACT1, the control device 31 of the information processing terminal 13 starts the sensor 34 and the camera 35 (ACT102). In ACT102, for example, the control device 31 starts the sensor 34 and the camera 35 based on the user's operation.

As in ACT2, the control device 31 estimates the position of the wireless tag communication apparatus 1 (ACT103). ACT103 may be a process carried out by the positional information processing unit 310 implemented by the control device 31.

As in ACT3, the control device 31 acquires the position of the wireless tag communication apparatus 1 (ACT104). ACT104 may also be a process performed by the positional information processing unit 310 implemented by the control device 31. The control device 31 stores the positional information in the memory 32.

As in ACT4, the control device 31 scans the RFID tags of the merchandise items displayed on the shelf (ACT105).

As in ACT5, the control device 31 acquires the scan result (ACT106). ACT106 may also be a process performed by the scan information processing unit 311 implemented by the control device 31. In ACT106, for example, the control device 31 acquires the read count of the tags based on the tag information as the scan result. The control device 31 may also acquire the irradiation time of the radio waves by the wireless tag communication unit 23 as the scan result. The control device 31 may acquire the strength of the radio waves by the wireless tag communication unit 23 as the scan result. The control device 31 stores the scan result as scan information in the memory 32. The control device 31 may also store a label based on the scan result in the memory 32.

As in ACT6, the control device 31 displays the objects on the display 14 based on the scan information (ACT107). ACT107 may also be a process performed by the display processing unit 312 implemented by the control device 31. In ACT107, for example, the control device 31 displays on the display 14 an image in which an object is overlapped or combined at the position corresponding to the scan region of the camera image acquired from the camera 35.

Based on the object data, the control device 31 may display the objects associated with the values of the labels at the positions corresponding to the scan region. The control device 31 may display the different objects on the display 14 in accordance with the labels. For example, the control device 31 may display the different objects in accordance with the read count of the tags read by the reader apparatus 10. The display processing unit 312 may display the different objects in accordance with the irradiation time of the radio waves by the reader apparatus 10.

The control device 31 may change the display mode of the object based on the time information included in the scan information. For example, the control device 31 may display the different objects in accordance with the time elapsed from the scan time. When the time elapsed from the scan time exceeds the predetermined time, the control device 31 may change the display form of the objects.

As in ACT7, the control device 31 determines whether an ending button for ending the scan has been selected (ACT108).

When the ending button is selected (YES in ACT108), the process ends. When the ending button is not selected (NO in ACT108), the process returns from ACT108 to ACT103.

The control device 31 outputs the scan information indicating the scan result to the server 2 (ACT109). ACT109 may also be a process performed by the communication processing unit 313 implemented by the control device 31. The control device 31 may output the scan information to the server 2 whenever the scan result is acquired.

The server 2 acquires the scan information from the information processing terminal 13 (ACT202). In ACT202, for example, the server 2 stores the scan information in the memory in association with the user ID.

The server 2 performs point processing based on the scan information (ACT203). In ACT203, for example, the server 2 calculates points based on the scan information. The server 2 may calculate different points in accordance with the values of the labels. For example, the server 2 may calculate the different points in accordance with the read count of the tags. The server 2 may also calculate different points based on the irradiation time of the radio waves. Specifically, the server 2 may add more points as the read count is more. The server 2 may add more points as the irradiation time of the radio waves is longer.

The server 2 may also calculate points in accordance with whether a predetermined merchandise item is scanned. For example, when a position at which the predetermined merchandise item is displayed is included in the scan region, the server 2 may add points.

According to this example, the wireless tag communication apparatus 1 can display the objects on the camera image based on the scan results by the customer. Therefore, the wireless tag communication apparatus 1 can visualize the scan results by the customer. Since the customer can easily view the scan results, the customer can perform the inventory task with a game feeling. The information processing system S can provide a reward to the customer in accordance with the scan result. Therefore, the information processing system S can motivate the customer to perform the inventory task. Accordingly, the information processing system S can address an issue of staff shortages in the inventory task.

### Other Embodiments

In the embodiment described above, the above description is given on the assumption that a program executed by a control device is stored in advance in a memory within an apparatus. However, the program executed by the control device may also be downloaded to the apparatus from a network, or installed onto the apparatus from a storage medium. The storage medium may be any storage medium such as a CD-ROM that can store a program and can be read by the apparatus. The functions obtained through pre-installation or downloading may also be implemented in cooperation with an operating system (OS) or the like within the apparatus.

The information processing terminal 13 may be implemented with one electronic apparatus or may be implemented by a plurality of electronic apparatuses to which functions are distributed.

The above-described embodiment may be applied to a method performed by a system. The above-described embodiment may be applied to a program that can cause a computer of a system to perform each function. The above-described embodiment may be applied to a recording medium that stores the program.

Each of one or more calculation circuits included in a processing circuit performs one or more processes among a plurality of processes. When the processing circuit is configured with a single calculation circuit, the single calculation circuit performs all of a plurality of processes. When the processing circuit is configured with a plurality of calculation circuits, each of the plurality of calculation circuits performs some of the plurality of processes. Some of the plurality of processes may be one of the plurality of processes or two or more of the plurality of processes. When the processing circuit is configured with the plurality of calculation circuits, the plurality of calculation circuits may be included in one apparatus or may be distributed to a plurality of apparatuses.

The program may be transferred in a state of being stored in an electronic apparatus according to an embodiment or may be transferred in a state of not being stored in an electronic apparatus. In the latter case, the program may be transferred via a network or may be transferred in a state where the program is recorded on a recording medium. The recording medium is a non-transitory tangible medium. The recording medium is a computer-readable medium. The recording medium may be a computer-readable medium capable of storing a program, such as a CD-ROM or a memory card and a specific form of the recording medium does not matter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing terminal, comprising:
an interface device connected to a reader apparatus that is configured to read RFID tag information from RFID tags;
a camera configured to capture an image;
a control device configured to execute a program for operating the information processing apparatus;
wherein the control device executes the program to:
display an augmented reality (AR) interface on top of the image captured by the camera;
estimate a location of the information processing terminal;
acquire the RFID tag information read by the reader apparatus; and
transmit the acquired RFID tag information to a server.

2. The information processing terminal according to claim 1, further comprising:
a sensor configured to generate acceleration or gyro data based on movement of the information processing terminal, wherein the control device estimates the location of the information processing terminal based on the acceleration or gyro data.

3. The information processing terminal according to claim 1, wherein the control device estimates the location of the information processing terminal based on AR markers detected in images captured with the camera, and each of the AR markers has a known location.

4. The information processing terminal according to claim 2, wherein the position information is represented by XYZ coordinates and stored in the memory of the information processing terminal.

5. The information processing terminal according to claim 1, wherein the AR interface includes AR objects corresponding to products that are in the captured image.

6. The information processing terminal according to claim 1, wherein, when the number of RFID tags read by the reader apparatus and corresponding to one of the products is greater than an average number of said one of the products, the AR object representing the product is displayed with an increased size or deeper color.

7. The information processing terminal according to claim 1, wherein, when an amount of time that has elapsed since the RFID tag corresponding to one of the products was read by the reader apparatus exceeds a predetermined amount of time, the AR object representing the product is displayed with an increased size or deeper color.

8. The information processing terminal according to claim 1, wherein
the control device transmits the acquired RFID information and timing information indicating when the RFID information was acquired by the reader apparatus to the server, which stores the RFID information and the timing information in a memory of the server.

9. The information processing terminal according to claim 8, wherein the control device acquires a user ID of a customer obtained via the camera.

10. The information processing terminal according to claim 9, wherein the server acquires the user ID of the customer and stores the RFID information and the timing information in the memory of the server in association with the user ID of the customer.

11. The information processing terminal according to claim 10, wherein the server performs points processing to award the customer an incentive in accordance with the RFID tag information and the timing information acquired by the customer and transmitted to the server.
